(19) United States
(12) Patent Application Publication
(10) Pub. No.: US 2002/0194268 A1
(43) Pub. Date: Dec. 19, 2002

(54) Distribute object mechanism

(76) Inventor: Benjamin Joseph Lai, Elwood (AU)

Correspondence Address: Peter S. Canelias, Attorney at Law, 14th Floor, 445 Park Avenue, New York, NY, 10022, US

(21) Appl. No.: 10/116,526

(22) Filed: Apr. 4, 2002

Related U.S. Application Data
(60) Provisional application No. 60/281,687, filed on Apr. 5, 2001.

(51) Int. Cl. G06F 15/16

(52) U.S. Cl. 709/203

(57) ABSTRACT

The present invention facilitates the ability of computer software applications to become “highly available” or redundant by distributing persistent data in real-time across to a backup system, with the added benefit that it can be retrofitted into currently available systems without the need to re-write the available computer software applications. The present invention creates a communication between a primary and backup servers so that any persisted or state information that exists on the primary server is automatically distributed to the backup without any extra coding effort. This is accomplished by inheriting from basic objects such as Hashtables, Vectors and BlockingQueue. Such inheritance not only completely emulates their respective functionality on a local level, but also distributes modifications to the objects via a communication protocol such as Remote Method Invocation (RMI).

### CLAIM FOR PRIORITY

This application claims the benefit of U.S. Provisional Application No. 60/281,687, filed Apr. 5, 2001.

### FIELD OF THE INVENTION

The present invention facilitates the ability of computer software applications to become “highly available” or redundant by distributing persistent data in real-time across to a backup system, with the added benefit that it can be retrofitted into currently available systems without the need to re-write the available computer software applications.

### BACKGROUND OF THE INVENTION

The present invention creates a communication between a primary and backup servers so that any persisted or state information that exists on the primary server is automatically distributed to the backup without any extra coding effort. This is accomplished by inheriting from basic objects such as Hashtables, Vectors and BlockingQueue. Such inheritance not only completely emulates their respective functionality on a local level, but also distributes modifications to the objects via a communication protocol such as Remote Method Invocation (RMI). RMI is a way that a programmer, using the Java programming language and development environment, can write object-oriented programs in which objects on different computers can interact in a distributed network. RMI is the Java version of what is generally known as a remote procedure call (RPC) but with the ability to pass one or more objects along with the request. An RPC is a protocol that one program can use to request a service from a program located in another computer in a network without having to understand network details.

High Availability is the ability of a system or process to continue providing service during a failure of one or more components of that system. A failure is an event caused either by an operator of such a system, or a failure of the system itself (hardware crash/software failure). In order to achieve a highly available service, a system must be designed to eliminate all single points of failure. Eliminating single points of failure requires additional hardware and software resources. High Availability solutions manage these resources and continue providing service during component failure.

There are differing terms used to describe the availability of a system, such as High Availability, Continuous Availability, and Permanent Availability. The definition of High Availability used herein is that end users (users include external processes that communicate with the server, such as a client application) can access the system at substantially all times. Typically, a High Availability system provides 99.999 percent average availability, or roughly five minutes of unscheduled downtime per year. The average downtime is about forty seconds and can be as little as twenty seconds.

The invention offers a unique level of granularity not previously used in High Availability systems. Most systems work on a transaction concept which requires roll back in all of the subsystems in case of failure or malfunction. Subsystems using the present invention of a distributed objects mechanism centralized this synchronization to a single subsystem in the design, simplifying both the design and implementation. Although distribute objects are not a new concept; the present invention combines distributed objects with a High Availability Manager to produce a system which is both simple to implement and robust.

Current applications use a standard blocking queue, which processes messages on a “first in” basis. A distributed block queue finds the location to maintain the state. In the past, a distributed database would process messages though all subsystems on a per transaction basis, which locked into one processing.

The previous persistence systems used a hardware-to-hardware backup system with at least two servers and databases. This does not work well for high availability systems due to the time lag. The present invention bypasses the database/hardware storage system and persists transaction data through a software mechanism. The resulting increase in the speed of availability makes the present invention useful in many High Availability systems. Although the preferred embodiment is directed to financial information exchange, the invention is useful in conjunction with any High Availability system, such as those used for air traffic control.

### SUMMARY OF THE INVENTION

The invention takes the current subsystem state information and distributes it automatically into backup. This means that the system does not have to be processing transactions with multi-processors with a redundant set of information on a backup system. Objects can be serializable with JAVA, i.e., written to and read from any input/output (I/O) device.

The invention may be used to create new high availability applications or be retrofitted to currently available applications. The ability to take existing objects and distribute them without affecting most of the existing subsystems drastically reduces integration time.

In the preferred embodiment, server engines are distributed across numerous independent machines and networks, to achieve High Availability. Multiple server engines and multiple clients can connect numerous FIX sessions in a single, uninterruptible logical FIX connection. On the client application side, the client has the ability to determine when a server is down. This refers to the case where a single engine process terminates, and not to the event that a FIX connection is dropped. The supporting mechanism is interface specific. However, all supported interfaces will raise an event if a server is down. The client also has a list of alternative servers with which to connect. This is implemented by adding a list of servers to the client's configuration files. The client also has the ability to disconnect from a dead server and re-initiate a connection to a new primary server. When a server disconnects, the client cycles through the list of available servers and attempts a reconnection to the next server. If the server is not the primary, then it rejects the client's connection. The client then tries the next server on the list, and so on.

On the system side, the system allows multiple protocol connections from multiple server engines with multiple clients that act as a single connection. The system has the ability to determine the primary server. On startup, a server records the current time to millisecond accuracy and disables all of its client interfaces. It then cycles through all of the servers on its list. The server with the oldest startup time becomes the primary. All secondary servers then connect to the primary and identify themselves as secondary servers. The system has the ability to distribute all messages from the primary engine to the secondary engine(s). The primary server broadcasts all transactions to the secondary servers, and then begins responding to clients' requests. This allows the clients and servers to synchronize FIX messages, eliminating dropping of messages. The system also has the ability to reject connections from clients that connect to the engine when it is not the primary.

### BRIEF DESCRIPTION OF THE DRAWINGS

FIG. 1 is a functional block diagram of two machines in a cluster;

FIG. 2 is a flow diagram showing address takeover;

FIG. 3 is a flow diagram showing the steps taken in a network failure;

FIG. 4 is a flow diagram showing the steps taken in software failure;

FIG. 5 is a flow diagram showing database synchronization;

FIG. 6 is a flow diagram showing a primary server search;

FIG. 7 is a functional block diagram showing the distribute object mechanism.

### DETAILED DESCRIPTION OF THE INVENTION

The present invention is described herein by way of a preferred embodiment, showing the invention as cooperating (bundled) with a Financial Information Exchange (FIX) server software engine (brand name Coppelia, Javelin Technologies, Inc.). A transaction is defined herein as an interchange between two things. The FIX server software engine is a software solution for sending and receiving messages electronically that are compliant with FIX versions (3.0, 4.0, 4.1 and 4.2). FIX is an open protocol enabling on line securities transactions. All message types that are specified by the FIX Protocol for these versions are supported.

A FIX message is sent from the FIX server software engine to users who connect via a plurality of middlemen, the message then sent to a financial institution. The message is converted from raw data to internal data and validated. It is then passed to a logger for persistence. The mechanism is a distributed blocking queue, which reads and writes to a disk, and is batched one to two hundred messages at a time. The distributed blocking queue resides between the logger queue and automatically distributes the data on a per message basis, each being independent of the other.

If the system goes down, the persistent storage becomes the primary source. The invention offsets the latency period involved in using a traditional disk backup system, 500 messages per second distributed, persistent to disk is about 20 messages per second.

A cluster is two or more server engines working in unison on independent platforms to implement a High Availability service. One engine acts as the primary service provider and the other(s) act as hot-secondaries, waiting their turn to assume the role of a primary. The group of engines (cluster) remains up to date.

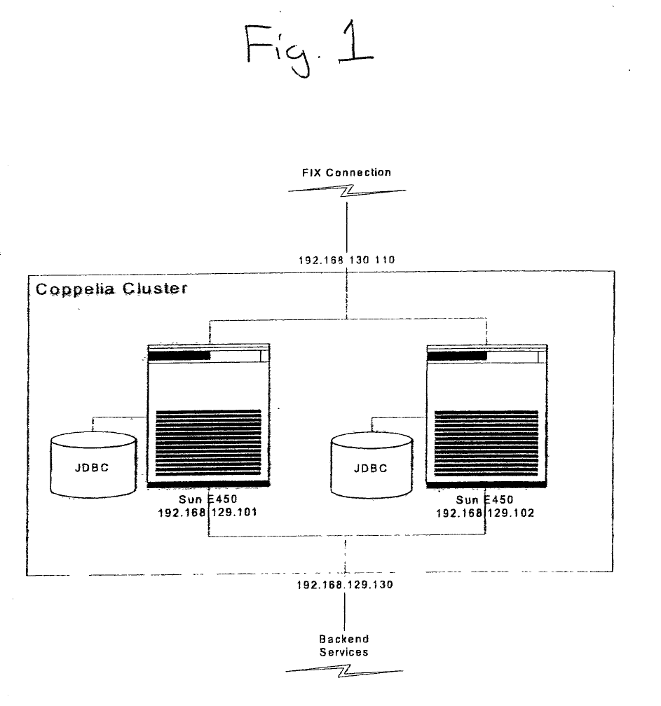

FIG. 1 illustrates the concept of a High Availability engine cluster. The purpose of the High Availability system is to present users with a single view of the FIX service. This provides a layer of abstraction between users and any of the internal workings of the system. Any failure inside the cluster only results in a disconnection from the service followed by a reconnection. The engine achieves this behavior by assigning a logical Internet Protocol (IP) address to a cluster. A logical IP address is a single IP address that represents a cluster.

FIG. 1 shows two machines in a cluster. For simplicity, each machine contains two independent network cards connected to two different subnets. In a production environment, it is preferred that each machine have four network cards: two redundant cards for each segment. The external FIX connection(s) and any services or processes on the backend have their own (physical) IP address to connect to the cluster service.

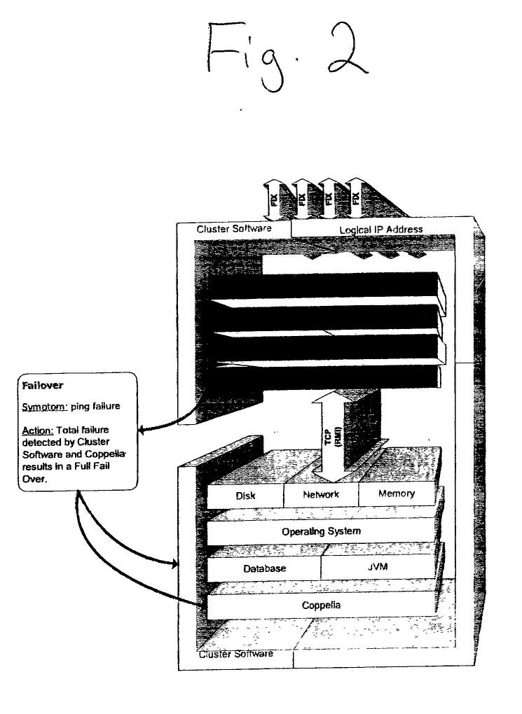

FIG. 2 shows an IP address takeover. If an engine FIX server, or service, becomes unavailable, another machine in the cluster automatically takes over. This machine is a hot stand-by. An IP address takeover involves two servers, each with their own (fixed) IP address and a shared floating IP address. The floating IP address is assigned to the primary server. An IP address takeover begins with the secondary server bringing up an interface for the floating IP address. An IP alias is used, which assigns a second logical interface on an existing physical interface. Once the interface is up, the secondary server is able to accept messages for the floating IP address. The fail over occurs on the occurrence of a symptom, here a ping failure. The action taken is the detection of total failure by the cluster software and the engine and results in a full fail over.

The engine with High Availability uses RMI to connect and communicate with other engine servers within the same cluster. Traditionally, Java applications that use RMI require an rmregistry server to do the lookup and object binding. To reduce the chance of failure or errors, the High Availability engine incorporates this server into its Java Virtual Machine.

The engine with High Availability incorporates internal features that ensure the system operates correctly. As an extension of this concept, the engine pings external devices (that is, their Well Known Addresses (WKAs)) to ensure communication to the outside. No single server in the cluster can fully start up or become the primary server until it can successfully ping at least one WKA. An example of a WKA is a router on the network, or the Domain Name System (DNS). The DNS is the way the Internet domain names are located and translated into IP addresses. A domain name can be a meaningful and easy-to-remember “handle” for an Internet address. A DNS server is typically located within close geographic proximity to the network. It maps the domain names in an Internet request or forwards the request to other servers on the Internet. Some firms maintain their own DNS servers as part of their network.

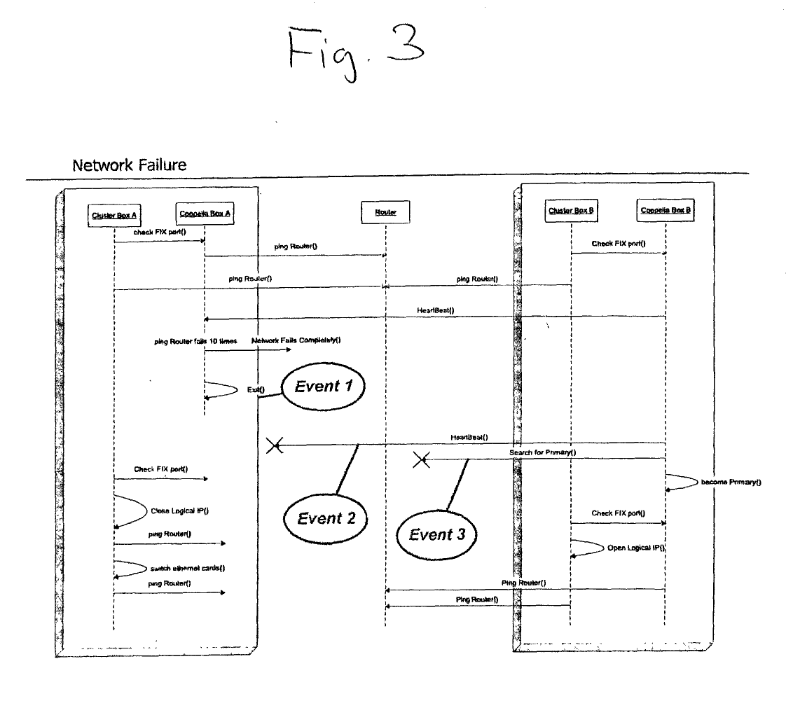

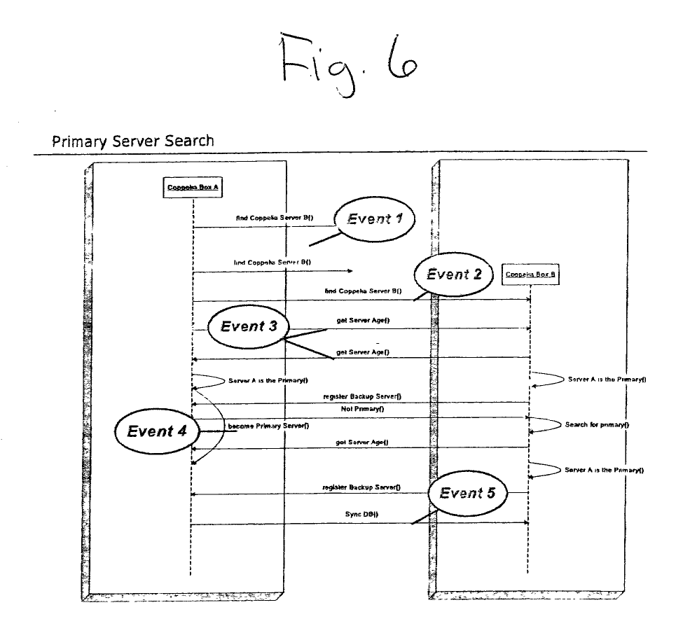

FIG. 3 shows the scenario of network failure. The diagram describes the event of a network failure, and the steps taken by the system as a reaction to such an event. At event 1, the current primary server detects the failure of network communications. That means consequently that heartbeats between the two systems are no longer exchanged at event 2. Therefore, the search for a new primary server begins, event 3 (see also FIG. 6).

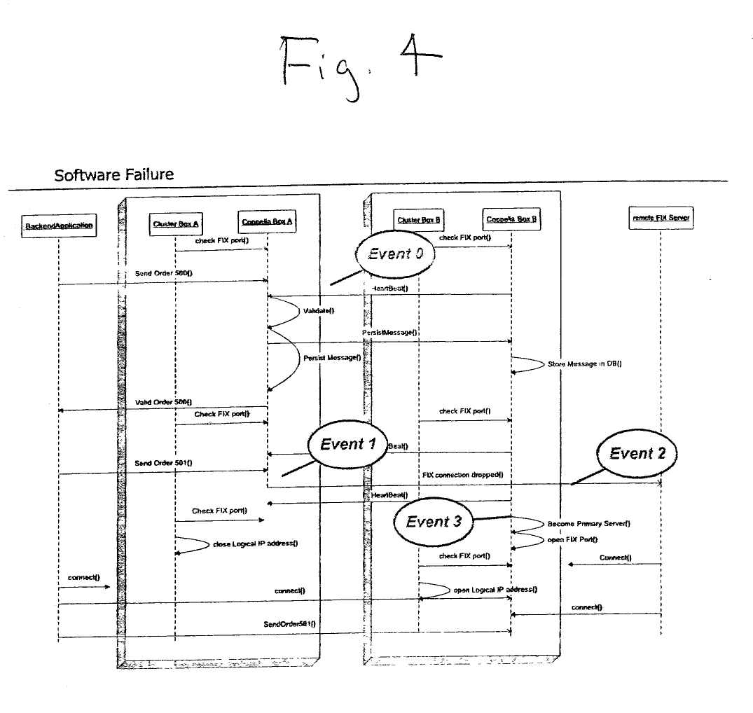

FIG. 4 shows the scenario of software failure, the event that one of the cluster members (servers) fails. Normal processing of messages (heartbeats, orders, etc.) takes place from event 0 up to event 1. At event 1, a failure of software occurs within the server A (the current primary server). As a result, the FIX connection to the remote FIX server is dropped, event 2. At event 3, the search for a primary server starts and completes (see also FIG. 6), and server B continues processing messages between the client application and the remote FIX server.

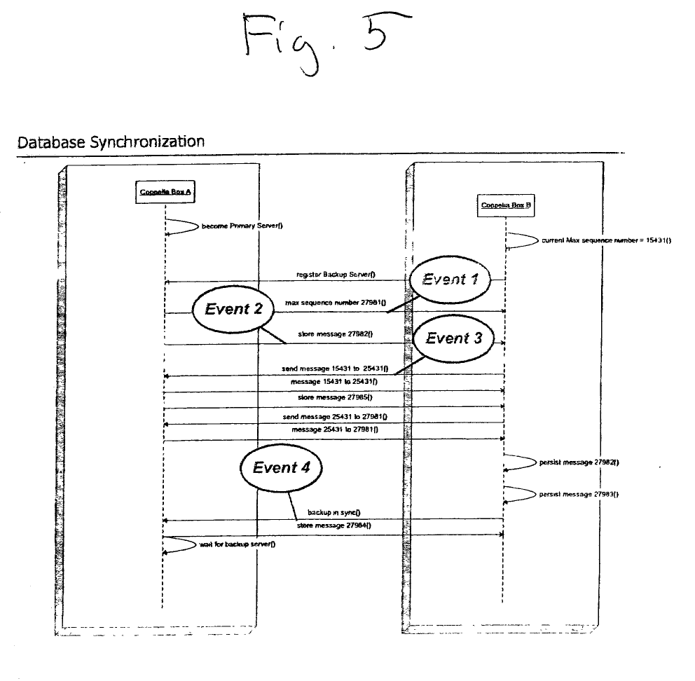

FIG. 5 shows database synchronization, i.e., how the system achieves complete synchronization of messages between members of the cluster. Server A (the current primary) informs server B that the last sequence number processed by it is 27981, event 1. Subsequently, server A attempts to store the next message with sequence number 27982, event 2. At event 3, the secondary server B requests to be synchronized with server A. The primary server sends the requested information. This process repeats one more time in this example, until the secondary server B notifies the primary server A that it is now in sync with it, event 4.

FIG. 6 shows the primary server search, describing the process followed by the system when a primary server is to be determined. On startup of a server configured as a member of a cluster, each such server searches for other servers near it, event 1. Eventually, after all servers are started, server A “finds” server B, event 2. Both servers determine their respective start times, event 3, and the oldest one becomes the primary, event 4. Server B registers as secondary with server A. Server A—the primary—synchronizes its database with the newly registered secondary server, event 5 (see also FIG. 5).

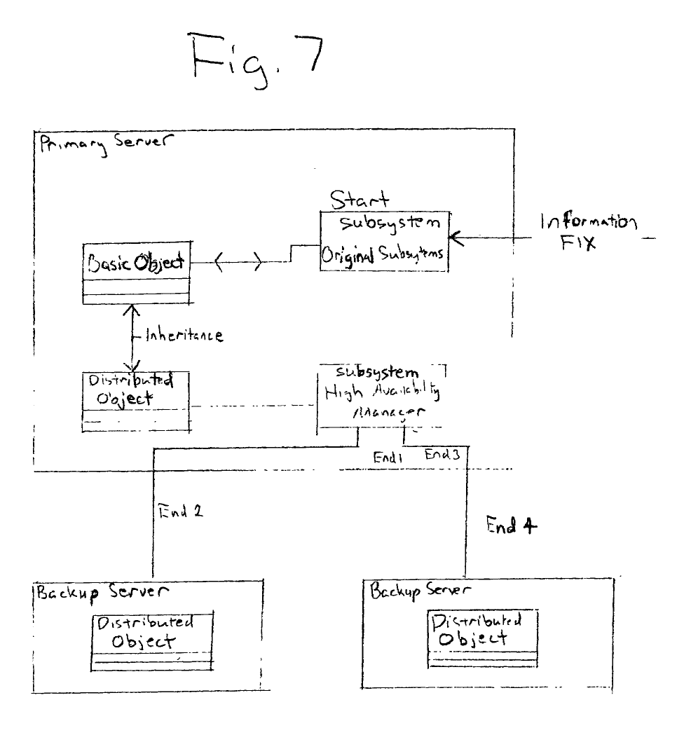

FIG. 7 shows the functioning of the distribute object mechanism. FIX information is transmitted to the primary server at the start, and to the original subsystems, which communicate with the basic object. The basic object transfers information via inheritance to the distributed object. The distributed object is transmitted to the High Availability Manager, which sends the distributed object to the backup servers. Two backup servers are shown, but the High Availability Manager may transmit distributed objects to as many or as few as desired in a given application.

Since other modifications or changes will be apparent to those skilled in the art, there have been described above the principles of this invention in connection with specific apparatus and method steps, it is to be clearly understood that this description is made only by way of example and not as a limitation to the scope of the invention.

What is claimed is:

1. A distribute object mechanism comprising:
a primary server having an original subsystem for receiving information, a basic object, a distributed object, and a high availability manager;
said basic object in communication with said distributed object for the transfer of information by inheritance;
said high availability manager in communication with said distributed object for receiving said distributed object; and
a backup server in communication with said high availability manager for receiving said distributed object.

2. The distribute object mechanism of claim 1, further comprising a second backup server in communication with said high availability manager.

3. The distribute object mechanism of claim 1, wherein said information is formatted compatible with a financial information exchange protocol.

4. A process of determining a primary server, comprising the steps of:
configuring a plurality of servers as members of a cluster;
a failure initiating a search for a primary server;
each server searching for other servers;
configured server A, operably coupled to a database, finding server B;
servers A and B determining their respective start times;
servers A and B selecting an oldest start time as a primary start time; and
server B registering as secondary server with server A.

5. The process of claim 4, further comprising the step of:
server A synchronizing said database with registered secondary server B.

6. The process of claim 4, wherein said failure is a software failure.

7. The process of claim 4, wherein said failure is a network failure.

8. A method of database synchronization of messages comprising the steps of:
a primary server A informing secondary server B of a last sequence number processed by primary server A.
primary server A attempting to store a subsequent message with a sequence number having a value different from said last sequence number;
server B requesting to be synchronized with primary server A;
primary server A sending requested information; and
secondary server B notifying primary server A that server B is synchronized with primary server A.

9. A method of internet protocol address takeover, comprising the steps of:
a failover occurring upon a symptom;
a primary server A and a secondary server B each having a fixed internet protocol address and sharing a floating internet protocol address;
assigning said floating internet protocol address to the primary server A;
secondary server B activating an interface for the floating internet protocol address;
an internet protocol alias assigning a second logical interface on an existing physical interface; and
said secondary server B accepting messages for said floating internet protocol address.

10. The method of claim 9, wherein said symptom is an occurrence of a ping failure.
